(19) United States
(12) Patent Application Publication
(10) Pub. No.: US 2024/0292272 A1
(43) Pub. Date: Aug. 29, 2024

(54) INTELLIGENT, POLICY-BASED NETWORK SELECTION

(71) Applicant: DISH Network L.L.C., Englewood, CO (US)

(72) Inventor: In-Kyung KIM, Highlands Ranch, CO (US)

(73) Assignee: DISH Network L.L.C., Englewood, CO (US)

(21) Appl. No.: 18/173,272

(22) Filed: Feb. 23, 2023

(51) Int. Cl. H04W 28/08; H04W 28/02; H04W 48/18

(52) U.S. Cl. CPC H04W 28/0925; H04W 28/0215; H04W 48/18

(57) ABSTRACT

Intelligent, policy-based network selection for telecommunications networks is disclosed. A network is selected for user equipment (UE) to switch/attach to based on policy logic incorporated into the UE, the carrier network, or both. The UE is dynamically configured with improved or optimal parameters for the selected network. The UE may be configured to access all of the capabilities of the selected network that its hardware supports. The carrier network may also include logic that assists with determining when to switch networks and which network to switch to. Such information may assist in determining which network is optimal for the given policy.

### FIELD

The present invention generally relates to telecommunications networks, and more specifically, to intelligent, policy-based network selection for telecommunications networks.

### BACKGROUND

Telecommunications networks for existing carriers provide different services and have different capabilities. Specifications and validation outcomes from original equipment manufacturers (OEMs) are inherited. Also, different bands may be supported by different carriers. For instance, AT&T®, Verizon®, and T-Mobile® support 4G LTE bands 2, 4, and 5, but Sprint® does not. Tables 1 and 2 below list the supported 4G LTE and 5G bands, respectively, for AT&T®, Verizon®, T-Mobile®, and Sprint®.

TABLE 1
4G LTE BANDS SUPPORTED BY CARRIERS

| Carrier: | Supported 4G LTE Bands: |
|---|---|
| AT&T ® | 2, 4, 5, 12, 14, 17, 29, 30, 66 |
| Verizon ® | 2, 4, 5, 13, 46, 48, 66 |
| T-Mobile ® | 2, 4, 5, 12, 25, 26, 41, 66, 71 |

TABLE 2
5G BANDS SUPPORTED BY CARRIERS

| Carrier: | Supported 5G Bands: |
|---|---|
| AT&T ® | n5, n77, n260 |
| Verizon ® | n2, n5, n66, n77, n260, n261 |
| T-Mobile ® | n41, n71, n260, n261 |

However, current user equipment (UE) devices attach to the home network for the carrier that the user subscribes to, when possible, but have suboptimal performance on other networks when roaming. Accordingly, an improved and/or alternative approach may be beneficial.

### SUMMARY

Certain embodiments of the present invention may provide solutions to the problems and needs in the art that have not yet been fully identified, appreciated, or solved by current telecommunications technologies, and/or provide a useful alternative thereto. For example, some embodiments of the present invention pertain to intelligent, policy-based network selection for telecommunications networks.

In an embodiment, one or more non-transitory computer-readable mediums store one or more computer programs for performing policy-based network selection. The one or more computer programs are configured to cause at least one processor to determine, based on a policy for UE attached to a first carrier network, that the UE should attach to a different carrier network. The one or more computer programs are also configured to cause at least one processor to determine a second carrier network that the UE should attach to based on the policy and instruct the UE to configure parameters of the UE for the second carrier network.

In another embodiment, a computer-implemented method for performing policy-based network selection includes determining, based on a policy of UE attached to a first carrier network, that the UE should attach to a different carrier network, by one or more computing systems. The computer-implemented method also includes determining a second carrier network that the UE should attach to based on the policy, by the one or more computing systems, and instructing the UE to configure parameters of the UE for the second carrier network, by the one or more computing systems. The parameters to be configured by the UE for the second carrier network include activation of one or bands, deactivation of one or more bands, changing a band selection order, changing a packet size, using carrier aggregation (CA), using a universal subscriber identity module (SIM), choosing a lowest cost available carrier network that meets minimum quality parameters, choosing a carrier network with a highest quality, or any combination thereof.

In yet another embodiment, a computing system includes memory storing computer program instructions for performing policy-based network selection and at least one processor configured to execute the computer program instructions. The computer program instructions are configured to cause the at least one processor to determine, based on a policy of UE attached to a first carrier network, that the UE should attach to a different carrier network. The computer program instructions are also configured to cause the at least one processor to determine a second carrier network that the UE should attach to based on the policy using, at least in part, a trained artificial intelligence (AI)/machine learning (ML) model for policy-based network selection. The computer program instructions are further configured to cause the at least one processor to instruct the UE to configure parameters of the UE for the second carrier network.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating multiple carrier networks and UE configured to implement intelligent, policy-based network selection, according to an embodiment of the present invention.

FIG. 2 is a flow diagram illustrating a process for selecting and switching carrier networks, according to an embodiment of the present invention.

FIG. 3 is a flow diagram illustrating another process for selecting and switching carrier networks, according to an embodiment of the present invention.

FIG. 4 is a flow diagram illustrating yet another process for selecting and switching carrier networks, according to an embodiment of the present invention.

FIG. 5 is a flowchart illustrating a process for performing policy-based network selection, according to an embodiment of the present invention.

FIG. 6A illustrates an example of a neural network that has been trained to supplement policy-based network selection, according to an embodiment of the present invention.

FIG. 6B illustrates an example of a neuron, according to an embodiment of the present invention.

FIG. 7 is a flowchart illustrating a process for training AI/ML model(s), according to an embodiment of the present invention.

FIG. 8 is an architectural diagram illustrating a computing system configured to perform policy-based network selection and/or aspects thereof, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to intelligent, policy-based network selection for telecommunications networks. A network is selected for UE to switch to and attach to based on policy logic incorporated into the UE, the carrier network, or both. The UE is dynamically configured with improved or optimal parameters for this network. Such dynamic configuration may include, but is not limited to, activation/deactivation of bands, changing band selection order, changing the packet size, use of carrier aggregation (CA), use of a universal subscriber identity module (SIM), choosing the lowest cost available carrier network that meets certain minimum quality parameters, choosing the carrier network with the highest quality, choosing multiple carriers for different services (e.g., one for voice and short message service (SMS) and another for data), selection of the optimum modem parameter for the selected network, selecting the network based on the quality differentiation (e.g., the network providing best voice service, the network providing best data service, the network having the lowest latency, the network providing the best quality for a specific application (e.g., steaming, real time chatting, etc.)), etc. In some embodiments, the UE may be configured to access all of the capabilities of the selected network.

The carrier network may also include logic that assists with determining when to switch networks and which network to switch to. For instance, the carrier network may monitor traffic over time and determine times of day, special events (e.g., concerts, sporting events, etc.), and the like that drive traffic higher. The network may leverage factors including, but not limited to, subscription information (e.g., data only, voice and data, high quality, low cost, etc.), a generic coverage map for each carrier network, and/or constructing a rich set of data based on quality reports from UE devices. The quality reports from the UE devices may be associated with the location. With this information, the network can create a precise quality heat map over the time as a cluster heat map or a spatial heat map. This process can be assisted by AI in some embodiments.

A heat map is a data visualization technique that shows the magnitude of one or more phenomena as color in two dimensions. The variation in color may be by hue or intensity, for example. In a cluster heat map, magnitudes are laid out into a matrix of fixed cell size whose rows and columns are discrete phenomena and categories, and the sorting of rows and columns is intentional and somewhat arbitrary, with the goal of suggesting clusters or portraying them as discovered via statistical analysis. By contrast, the position of a magnitude in a spatial heat map is forced by the location of the magnitude in that space, and there is no notion of cells, where the phenomenon is considered to vary continuously. For instance, user location density may be shown in a cluster heat map, signal strength may be shown in a spatial heat map over a geographical area (e.g., where signal-to-noise ratio (SNR) or signal to interference and noise ratio (SINR) are shown on a color scale), etc.

With this intelligence, the network will have knowledge as to selecting the best network for the UE meeting its service quality requirements and policy for a given time and location. The network can set a proper priority order for the network search. Also, the coverage map may allow the network to inform the UE not to search for a given network if it is not present in a location or has poor performance in that location. Such information may assist in determining which network is optimal for the given policy.

In some embodiments, the primary roaming network in the SIM profile configures the UE with the optimum parameters for the initial network that the UE connects to at activation. For instance, if the UE is purchased at an AT&T® store or a Verizon® store, the UE would be optimally configured for that network initially. In other words, software and hardware of the UE would be optimized for that carrier. If optimized for AT&T®, the UE may not support band n71 and outer bands, and AT&T® may also have a priority list for the bands it supports, a certain packet size that it uses, etc. The UE then dynamically reconfigures itself based on the actual network that the UE is attached to. For instance, if the UE initially configured for the AT&T® network switches to T-Mobile®, the UE settings may be changed so n71 is supported, n41 is used for better throughput, etc. Thereafter, the policy (e.g., the network quality, the service grade, the device location, the subscription, etc.) drives dynamic reconfiguration of the UE.

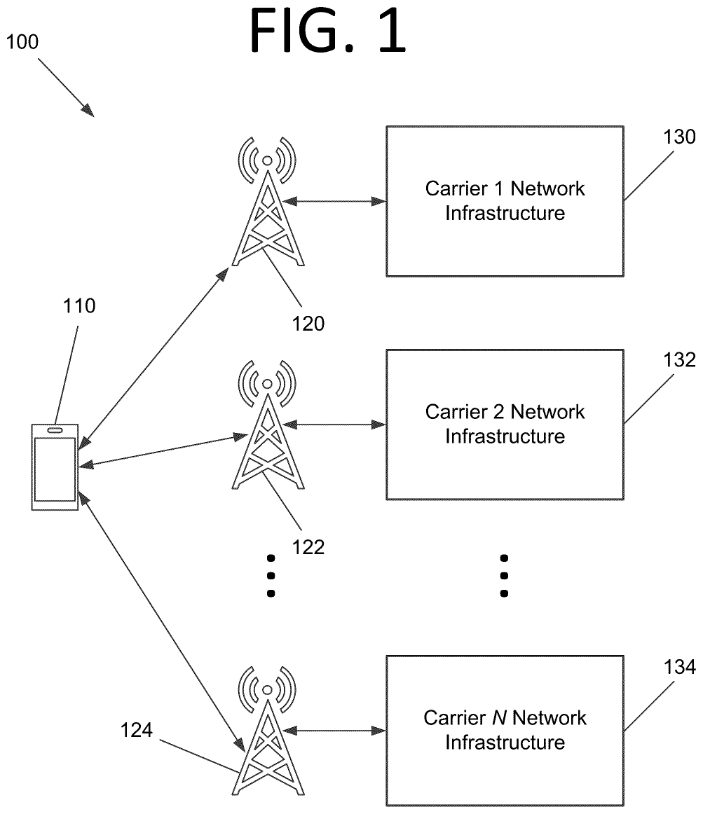

FIG. 1 is an architectural diagram illustrating multiple carrier networks and UE 110 configured to implement intelligent, policy-based network selection, according to an embodiment of the present invention. Carrier networks 1, 2, . . . , N each have respective radio access networks (RANs) 120, 122, 124 and carrier network infrastructure 130, 132, 134. Carrier network infrastructure 130, 132, 134 may include computing systems and other equipment associated with breakout edge data centers (BEDCs), regional data centers (RDCs), national data centers (NDCs), etc.

Carrier network infrastructure 130, 132, 134 may provide various network functions (NFs) and other services. For instance, BEDCs may break out User Plane Function (UPF) data traffic (UPF-d) and provide cloud computing resources and cached content to UE 110, such as providing NF application services for gaming, enterprise applications, etc. RDCs may provide core network functions, such as UPF for voice traffic (UPF-v) and Short Message Service Function (SMSF) functionality. NDCs may provide a Unified Data Repository (UDR) and user verification services, for example. Other network services that may be provided may include, but are not limited to, Internet Protocol (IP) multimedia subsystem (IMS) IMS+telephone answering service (TAS) functionality, IP-SM gateway (IP-SM-GW) functionality (the network functionality that provides the messaging service in the IMS network), enhanced serving mobile location center (E-SMLC) functionality, policy and charging rules function (PCRF) functionality, mobility management entity (MME) functionality, signaling gateway (SGW) control plane (SGW-C) and user data plane (SGW-U) ingress and egress point functionality, packet data network gateway (PGW) control plane (PGW-C) and user data plane (PGW-U) ingress and egress point functionality, home subscriber server (HSS) functionality, UPF+PGW-U functionality, access and mobility management (AMF) functionality, HSS+unified data management (UDM) functionality, session management function (SMF)+PGW-C functionality, short message service center (SMSC) functionality, and/or policy control function (PCF) functionality. It should be noted that additional and/or different network functionality may be provided without deviating from the present invention. The various functions in these carrier systems may be performed using dockerized clusters in some embodiments.

UE 110 determines which carrier network(s) to configure itself for and connect to based on a policy. For instance, the UE 110 may connect to a carrier network that provides a minimum level of service, that provides the highest connection quality, that has the best data speed over multiple bands, that has the lowest cost meeting certain minimum service quality criteria (e.g., a minimum signal-to-noise ratio (SNR), a minimum data speed, etc.), and the like. In some embodiments, different carrier networks may be used for different services, or multiple carrier networks may be used for the same service. For instance, multiple carrier networks may be used to collectively provide higher data rates, to perform multiple cloud computing tasks, etc. Voice traffic and Internet Protocol (IP) multimedia subsystem (IMS) traffic services may be provided by one carrier network and data traffic services may be provided by another carrier network in some embodiments.

In some embodiments, the policy may prioritize certain available bands over others. Bands and/or CA band combinations may be enabled or disabled based on the available networks. Carrier networks enabling functionality such as voice over new radio (VoNR), voice over LTE (VOLTE), etc. may be preferred over carrier networks that lack such services in some embodiments.

Various advantages may be provided by some embodiments. For instance, the UE configuration may be optimized for the carrier network(s) that are actually used, providing superior device performance. Also, the UE and carrier network(s) may make policy-based decisions regarding selecting the best carrier network(s) for services based on different and/or desired parameters. Furthermore, networks may be changed in real time or near-real time based on actual network congestion, RAN signal strength, etc.

Potentially more sophisticated server-side policy rules may be implemented in carrier networks and paired with policy rules implemented by the UE. For instance, prepaid low-end customers may be switched to a slower or otherwise less optimal network (or even disconnected entirely if no other network is available) when the network becomes too congested, but higher end customer connections may be maintained. The server-side logic may utilize artificial intelligence (AI)/machine learning (ML) to analyze network data and determine more optimal actions for various policies. For instance, AI/ML models may learn congestion patterns, determine events that are likely to impact service (e.g., applying natural language processing (NLP) to read news and identify such events and their times and locations), etc. Per the above, based on measurements received from UE devices, the network can obtain measurements of signal strength, SNR, signal to interference and noise ratio (SINR), throughput, call quality (e.g., call drop events, call setup failure events, mean opinion score (MOS), handover (HO) events, utilized frequencies and associated CA combos, etc.), and the like for each network associated with time and location in some embodiments. This may provide the basis for a service quality heat map and may serve as training data for machine learning and artificial intelligence purposes. In some embodiments, a rules engine of the UE that implements the policy on the device side may connect to the selected carrier network itself, but network signaling may be incorporated for provisioning. For instance, server-side computing systems may analyze loading at the carrier network core and determine whether to shed the UE from that network to provide real time load balancing.

Near-real time insight into performance across multiple networks may also be obtained. For instance, UE may communicate with server-side computing systems in the carrier network to determine information pertaining to that network's performance in some embodiments. Also, the UE may use its own information regarding detected signal strength, latency, etc.

Per the above, the most suitable network at a given time depends on the policy and which networks are available at that location. For instance, if there is a premium subscription, the networks of DISH®, AT&T®, T-Mobile®, etc. may be polled by the UE to determine which network has the best performance. This may include requesting network performance information from these networks from the carrier infrastructure. UE may monitor the performance of various available carrier networks in real time or near-real time in some embodiments, and this information may be provided to another carrier to intelligently inform the network switching policy.

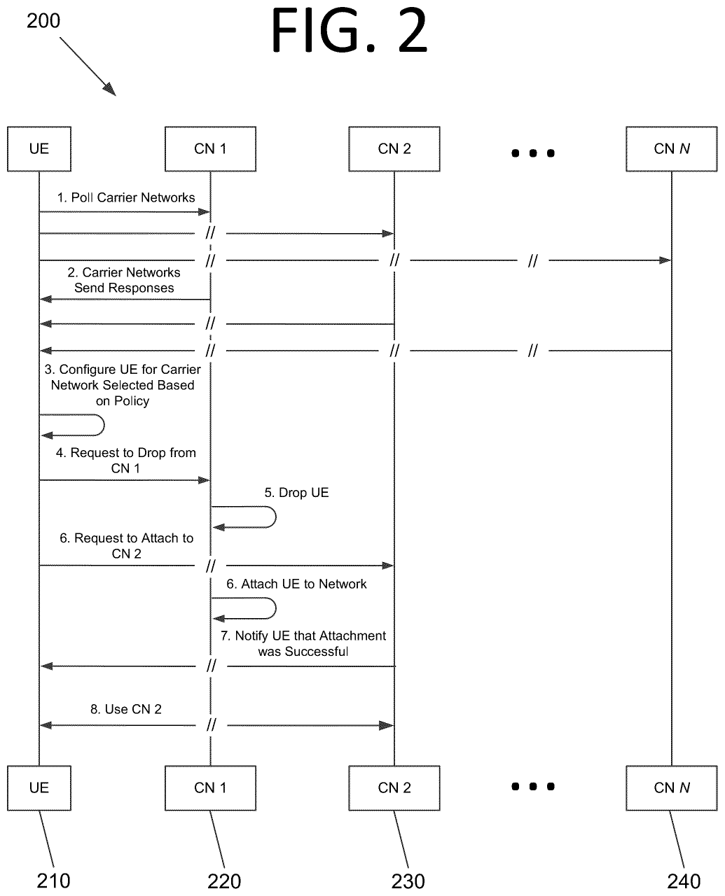

FIG. 2 is a flow diagram illustrating a process 200 for selecting and switching carrier networks, according to an embodiment of the present invention. The process begins with UE 210 polling available carrier networks CN 1 220, CN 2 230, through CN N 240 for network information, which these networks provide. This information may include, but is not limited to, subscription information, network congestion information, data speeds, information from analysis of the carrier network by AI/ML models, etc. The forward slashes are intended to indicate that the communications between UE 210 and a given carrier network does not pass through the other carrier networks.

Based on the polling information from CN 1 220, CN 2 230, through CN N 240, UE 210 determines based on a policy that it should switch networks—in this case, from CN 1 220 to CN 2 230. UE 210 changes its configuration from being optimized for CN 1 220 to being optimized for CN 2 230. This may include changing the bands and/or band order that is used, changing the packet size, etc. UE 210 then requests to drop from CN 1 220, and CN 1 220 drops UE 210. In some embodiments, these steps may occur in the opposite order.

UE 210 then requests to attach to CN 2 230, which is the preferred network based on the policy. CN 2 230 then attaches UE 210 to the network and notifies UE 210 that the attachment was successful. UE 210 then begins using CN 2 230 for communications.

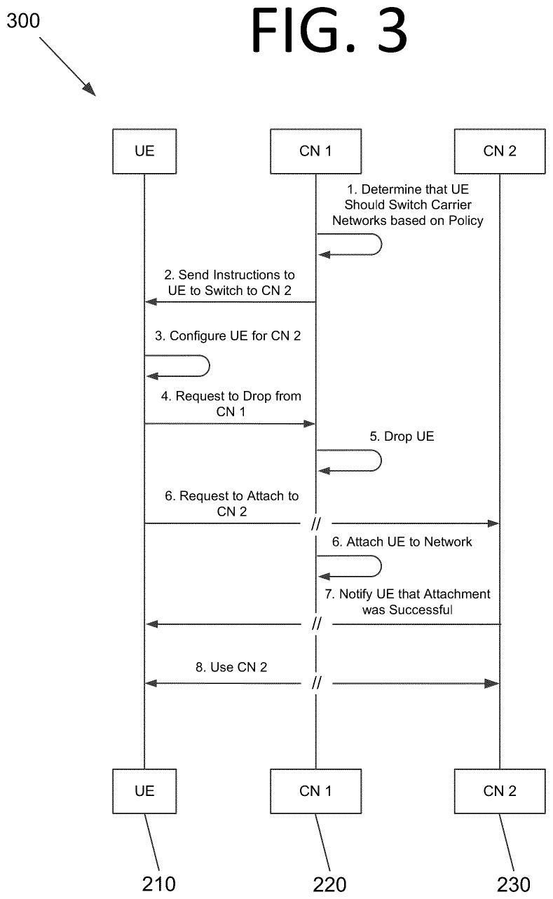

FIG. 3 is a flow diagram illustrating another process 300 for selecting and switching carrier networks, according to an embodiment of the present invention. The process begins with CN 1 220, which is the network UE 210 is currently using, determining that UE 210 should switch carrier networks based on the policy for that user/UE. This may be based on the user's subscription, the amount on congestion in CN 1 220, AI determination by AI/ML model(s) of CN 1 220 that an event is occurring at or near the location of UE 210 that may negatively affect service, etc. CN 1 220 then sends instructions to UE 210 to switch to another network—in this example, CN 2 230.

UE 210 configures itself for CN 2 230 (e.g., changing bands, band order, packet size, etc.) and requests to drop from CN 1 220, which CN 1 220 does. However, in some embodiments, CN 1 220 may drop UE 210 automatically after sending network switching instructions. UE 210 then requests to attach to CN 2 230. CN 2 230 attaches UE 210 to its network and notifies UE 210 that the attachment was successful. UE 210 then begins using CN 2 230.

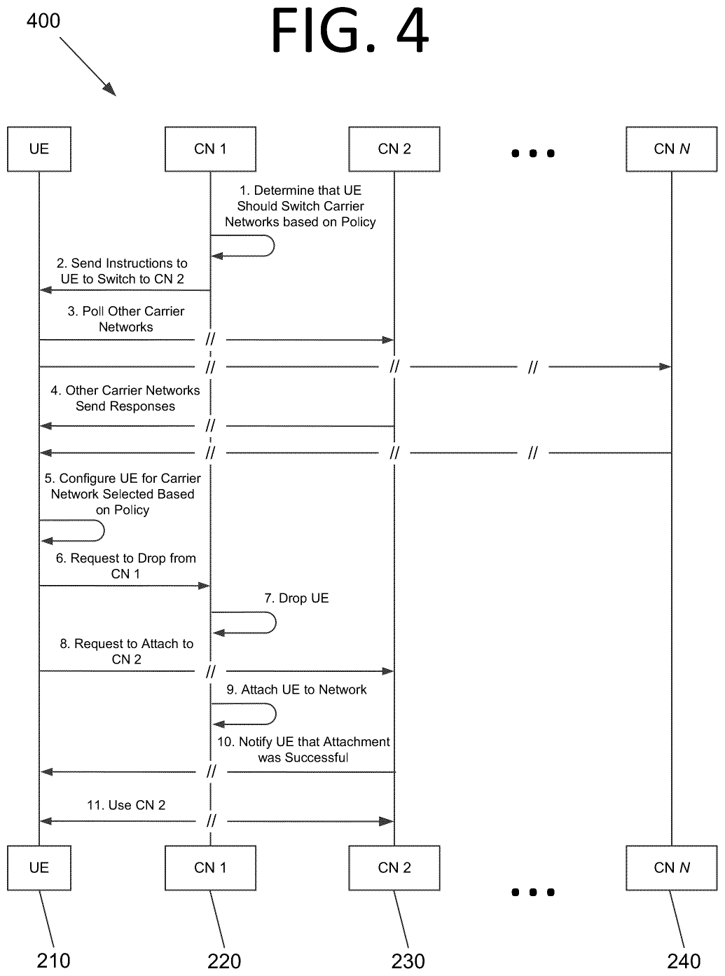

FIG. 4 is a flow diagram illustrating yet another process 400 for selecting and switching carrier networks, according to an embodiment of the present invention. The process begins with CN 1 220, which is the network UE 210 is currently using, determining that UE 210 should switch carrier networks based on the policy for that user/UE. This may be based on the user's subscription, the amount on congestion in CN 1 220, AI determination by AI/ML model(s) of CN 1 220 that an event is occurring at or near the location of UE 210 that may negatively affect service, etc. CN 1 220 then sends instructions to UE 210 to switch to another network.

However, unlike the scenario of FIG. 3, CN 1 220 does not indicate which network to switch to. Rather, UE 210 polls available carrier networks CN 2 230, through CN N 240 for network information, which these carriers provide. This information may include, but is not limited to, subscription information, network congestion information, data speeds, information from analysis of the carrier network by AI/ML models, etc.

Based on the polling information from networks CN 2 230 through CN N 240, UE 210 determines based on a policy that it should switch networks—in this case, from CN 1 220 to CN 2 230. UE 210 changes its configuration from being optimized for CN 1 220 to being optimized for CN 2 230. This may include changing the bands and/or band order that is used, changing the packet size, etc. UE 210 then requests to drop from CN 1 220, and CN 1 220 drops UE 210. In some embodiments, these steps may occur in the opposite order, or CN 1 220 may drop UE 210 after sending the instructions to switch networks to UE 210.

UE 210 then requests to attach to CN 2 230, which is the preferred network of CN 2 230 through CN N 240 based on the policy. CN 2 230 then attaches UE 210 to the network and notifies UE 210 that the attachment was successful. UE 210 then begins using CN 2 230 for communications.

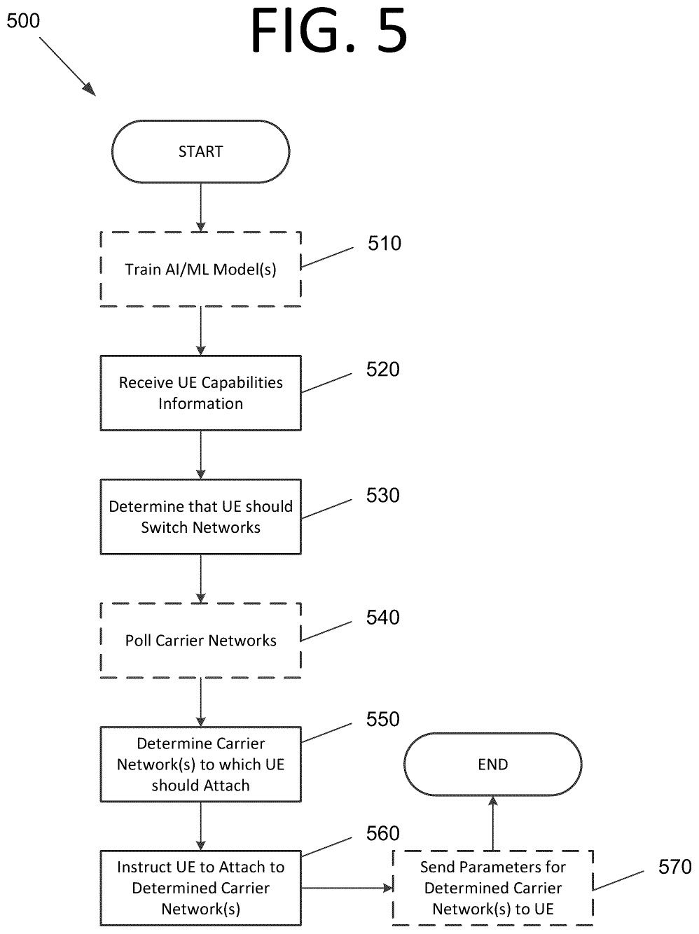

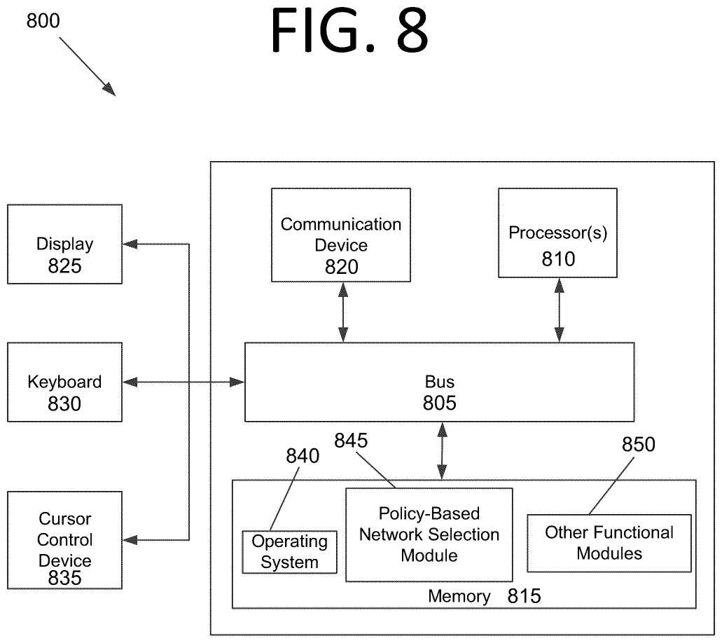

FIG. 5 is a flowchart illustrating a process for performing policy-based network selection, according to an embodiment of the present invention. The process begins with training an AI/ML model for policy-based network selection at 510 in some embodiments. The training may be performed using signal strength data, congestion data, location data, data pertaining to carrier networks, SNR data, SINR data, throughput data, call quality data, etc. Information providing hardware capabilities of the UE, software capabilities of the UE, or both, is received at 520. For instance, the UE may transit this information to a home carrier. Computing system(s) in the home carrier network (e.g., computing system 800 of FIG. 8 in some embodiments) determine, based on a policy for UE attached to a carrier network, that the UE should attach to a different carrier network at 530. In some embodiments, the home network computing system(s) poll a plurality of carrier networks for respective network information at 540 (e.g., polling for current network congestion statistics).

The computing system(s) then determine one or more other carrier networks that the UE should attach to based on the policy at 550. In some embodiments, more than one carrier network may be determined. For instance, one carrier network may be selected to provide data services and another carrier network may be selected to provide voice and SMS. The computing system(s) use the received hardware capabilities of the UE and/or software capabilities of the UE in the determining of the second carrier network that the UE should attach to based on the policy in some embodiments. If a plurality of carrier networks were polled at 540, this information may be used as well. In certain embodiments, the other carrier network(s) are determined based on a subscription of the UE, current or anticipated future congestion conditions on the home network, or a determination that an event likely to cause congestion conditions is occurring or will occur. In some embodiments, the trained AI/ML model is used to determine that the UE should attach to the different carrier network based on the policy, determine the second carrier network that the UE should attach to based on the policy, or both, as part of steps 530 and/or 550.

The computing system(s) instruct the UE to configure parameters of the UE for the second carrier network at 560. In some embodiments, the parameters to be configured by the UE for the second carrier network include activation of one or bands, deactivation of one or more bands, changing a band selection order, changing a packet size, using CA, using a universal SIM, choosing a lowest cost available carrier network that meets minimum quality parameters, choosing a carrier network with a highest quality, or any combination thereof. In some embodiments, the computing system(s) send the parameters to be configured for the determined carrier network(s) to the UE at 570.

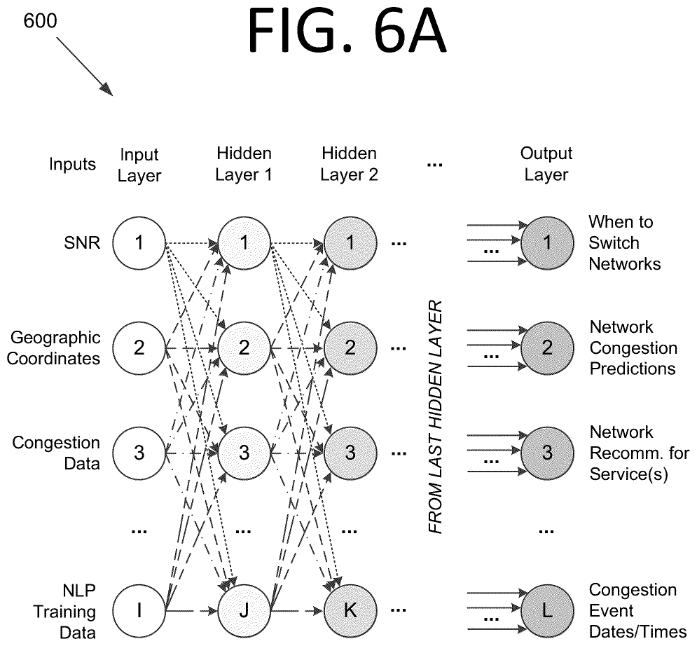

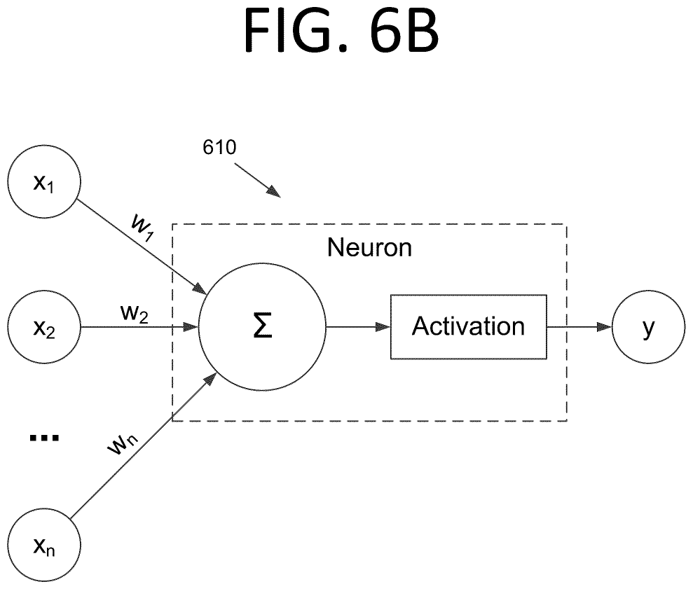

Per the above, AI/ML may be used to supplement policy-based network selection functionality. Various types of AI/ML models may be trained and deployed without deviating from the scope of the invention. For instance, FIG. 6A illustrates an example of a neural network 600 that has been trained to improve network switching policies, according to an embodiment of the present invention.

Neural network 600 also includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 600.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 6A, SNR, geographic coordinates, congestion data, NLP training data, etc. provided as the input layer are fed as inputs to the J neurons of hidden layer 1. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 600 without deviating from the scope of the invention. Indeed, in certain embodiments, the types of neurons in a given layer may not all be the same.

Neural network 600 is trained to assign a confidence score to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 610 is shown in FIG. 6B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 610 may thus be given by:

$$y = f ( x ) {\sum }_{i = 1}^{m} ( {w}_{i} {x}_{i} ) + bias \qquad ( 3 )$$

In this case, neuron 610 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

The goal, or “reward function” is often employed, such as for this case the successful identification of graphical elements in the image. A reward function explores intermediate transitions and steps with both short-term and long-term rewards to guide the search of a state space and attempt to achieve a goal (e.g., finding the best carrier network for a give service, determining when the network is likely to be congested, determining when to drop UE, etc.).

During training, various labeled data is fed through neural network 600. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form pⱼ(nⱼ)=ƒⱼ′(nⱼ), where nⱼ is the network activity at layer j (i.e., nⱼ=Wⱼoⱼ₋₁+bⱼ) where oⱼ=ƒⱼ(nⱼ) and the apostrophe ′ denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not generalize well to other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to enable semantic understanding to better predict event-based congestion or service interruptions due to an accident, for instance.

Some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

Natural language processing (NLP) techniques such as word2vec, BERT, GPT-3, ChatGPT, etc. may be used in some embodiments to facilitate semantic understanding. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

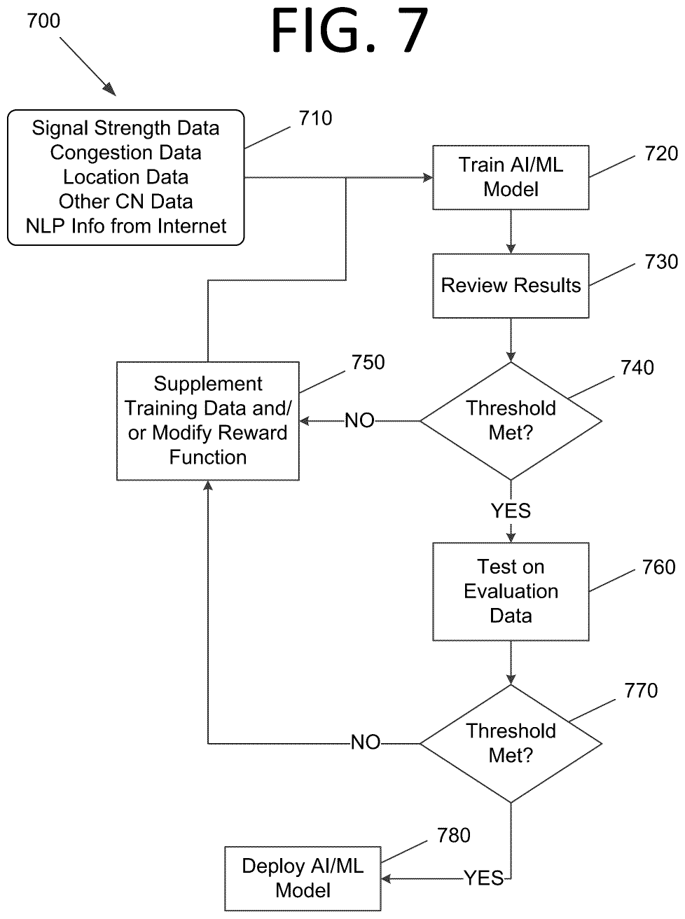

FIG. 7 is a flowchart illustrating a process 700 for training AI/ML model(s), according to an embodiment of the present invention. The process begins with providing training data, such as signal strength data, congestion data, location data, data pertaining to other carrier networks, NLP information from the Internet, words and phrases, a “thesaurus” of semantic associations between words and phrases such that similar words and phrases for a given word or phrase can be identified, etc. at 710, whether labeled or unlabeled. The nature of the training data that is provided will depend on the objective that the AI/ML model is intended to achieve. Indeed, any suitable training data may be used without deviating from the scope of the invention. For instance, measurements of signal strength, SNR, SINR, throughput, call quality, etc. Per the above, measurements from UE devices may provide the basis for a service quality heat map. Once the heat map has been generated, the AI/ML model could be trained based on the heat map information. The AI/ML model is then trained over multiple epochs at 720 and results are reviewed at 730.

If the AI/ML model fails to meet a desired confidence threshold at 740, the training data is supplemented and/or the reward function is modified to help the AI/ML model achieve its objectives better at 750 and the process returns to step 720. If the AI/ML model meets the confidence threshold at 740, the AI/ML model is tested on evaluation data at 760 to ensure that the AI/ML model generalizes well and that the AI/ML model is not over fit with respect to the training data. The evaluation data includes information that the AI/ML model has not processed before. If the confidence threshold is met at 770 for the evaluation data, the AI/ML model is deployed at 780. If not, the process returns to step 750 and the AI/ML model is trained further.

FIG. 8 is an architectural diagram illustrating a computing system 800 configured to perform policy-based network selection and/or aspects thereof, according to an embodiment of the present invention. In some embodiments, computing system 800 may be one or more of the computing systems depicted and/or described herein, such as UE, a carrier server, etc. Computing system 800 includes a bus 805 or other communication mechanism for communicating information, and processor(s) 810 coupled to bus 805 for processing information. Processor(s) 810 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 810 may also have multiple processing cores, and at least some of the cores may be configured to perform specific functions. Multi-parallel processing may be used in some embodiments. In certain embodiments, at least one of processor(s) 810 may be a neuromorphic circuit that includes processing elements that mimic biological neurons. In some embodiments, neuromorphic circuits may not require the typical components of a Von Neumann computing architecture.

Computing system 800 further includes a memory 815 for storing information and instructions to be executed by processor(s) 810. Memory 815 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 810 and may include volatile media, non-volatile media, or both. The media may also be removable, non-removable, or both.

Additionally, computing system 800 includes a communication device 820, such as a transceiver, to provide access to a communications network via a wireless and/or wired connection. In some embodiments, communication device 820 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 820 may include one or more antennas that are singular, arrayed, phased, switched, beamforming, beamsteering, a combination thereof, and or any other antenna configuration without deviating from the scope of the invention.

Processor(s) 810 are further coupled via bus 805 to a display 825, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina display, an In-Plane Switching (IPS) display, or any other suitable display for displaying information to a user. Display 825 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 830 and a cursor control device 835, such as a computer mouse, a touchpad, etc., are further coupled to bus 805 to enable a user to interface with computing system 800. However, in certain embodiments, a physical keyboard and mouse may not be present, and the user may interact with the device solely through display 825 and/or a touchpad (not shown). Any type and combination of input devices may be used as a matter of design choice. In certain embodiments, no physical input device and/or display is present. For instance, the user may interact with computing system 800 remotely via another computing system in communication therewith, or computing system 800 may operate autonomously.

Memory 815 stores software modules that provide functionality when executed by processor(s) 810. The modules include an operating system 840 for computing system 800. The modules further include a policy-based network selection module 845 that is configured to perform all or part of the processes described herein or derivatives thereof. Computing system 800 may include one or more additional functional modules 850 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 2-5 may be performed by computer program(s), encoding instructions for the processor(s) to perform at least part of the process(es) described in FIGS. 2-5, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 810 of computing system 800 of FIG. 8) to implement all or part of the process steps described in FIGS. 2-5, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable mediums storing one or more computer programs for performing policy-based network selection, the one or more computer programs configured to cause at least one processor to:
determine, based on a policy for user equipment (UE) attached to a first carrier network, that the UE should attach to a different carrier network;
determine a second carrier network that the UE should attach to based on the policy; and
instruct the UE to configure parameters of the UE for the second carrier network.

2. The one or more non-transitory computer-readable mediums of claim 1, wherein the one or more computer programs are further configured to cause the at least one processor to:
receive information providing hardware capabilities of the UE, software capabilities of the UE, or both; and
use the received hardware capabilities of the UE, software capabilities of the UE, or both, in the determining of the second carrier network that the UE should attach to based on the policy.

3. The one or more non-transitory computer-readable mediums of claim 1, wherein the parameters to be configured by the UE for the second carrier network comprise activation of one or bands, deactivation of one or more bands, changing a band selection order, changing a packet size, using carrier aggregation (CA), using a universal subscriber identity module (SIM), choosing a lowest cost available carrier network that meets minimum quality parameters, choosing a carrier network with a highest quality, or any combination thereof.

4. The one or more non-transitory computer-readable mediums of claim 1, wherein the second carrier network is determined for a first service and the one or more computer programs are further configured to cause the at least one processor to:
determine a third carrier network that the UE should attach to for a second service based on the policy; and
instruct the UE to configure the parameters of the UE for the third carrier network.

5. The one or more non-transitory computer-readable mediums of claim 4, wherein the first service comprises data and the second service comprises voice and short message service (SMS), or vice versa.

6. The one or more non-transitory computer-readable mediums of claim 1, wherein the one or more computer programs are further configured to cause the at least one processor to:
poll a plurality of carrier networks for respective network information; and
use the network information from the polled plurality of carrier networks in the determination of the second carrier network that the UE should attach to based on the policy.

7. The one or more non-transitory computer-readable mediums of claim 6, wherein the network information comprises current network congestion statistics.

8. The one or more non-transitory computer-readable mediums of claim 1, wherein
the first carrier network instructs the UE to configure the parameters of the UE for the second carrier network, and
the second carrier network is determined based on a subscription of the UE, current or anticipated future congestion conditions on the first carrier network, or a determination that an event likely to cause congestion conditions is occurring or will occur.

9. The one or more non-transitory computer-readable mediums of claim 1, wherein the one or more computer programs are further configured to cause the at least one processor to:
train an artificial intelligence (AI)/machine learning (ML) model for policy-based network selection using signal strength data, congestion data, location data, data pertaining to carrier networks, signal-to-noise ratio (SNR) data, signal to interference and noise ratio (SINR) data, throughput data, call quality data, or any combination thereof; and
use the trained AI/ML model to determine that the UE should attach to the different carrier network based on the policy, determine the second carrier network that the UE should attach to based on the policy, or both.

10. A computer-implemented method for performing policy-based network selection, comprising:
determining, based on a policy of user equipment (UE) attached to a first carrier network, that the UE should attach to a different carrier network, by one or more computing systems;
determining a second carrier network that the UE should attach to based on the policy, by the one or more computing systems; and
instructing the UE to configure parameters of the UE for the second carrier network, by the one or more computing systems, wherein
the parameters to be configured by the UE for the second carrier network comprise activation of one or bands, deactivation of one or more bands, changing a band selection order, changing a packet size, using carrier aggregation (CA), using a universal subscriber identity module (SIM), choosing a lowest cost available carrier network that meets minimum quality parameters, choosing a carrier network with a highest quality, or any combination thereof.

11. The computer-implemented method of claim 10, further comprising:
receiving information providing hardware capabilities of the UE, software capabilities of the UE, or both, by the one or more computing systems; and
using the received hardware capabilities of the UE, software capabilities of the UE, or both, in the determining of the second carrier network that the UE should attach to based on the policy, by the one or more computing systems.

12. The computer-implemented method of claim 10, wherein the second carrier network is determined for a first service the method further comprises:
determining a third carrier network that the UE should attach to for a second service based on the policy, by the one or more computing systems; and
instructing the UE to configure the parameters of the UE for the third carrier network, by the one or more computing systems, wherein
the first service comprises data and the second service comprises voice and short message service (SMS), or vice versa.

13. The computer-implemented method of claim 10, further comprising:
polling a plurality of carrier networks for respective network information, by the one or more computing systems; and
using the network information from the polled plurality of carrier networks in the determination of the second carrier network that the UE should attach to based on the policy, by the one or more computing systems.

14. The computer-implemented method of claim 13, wherein the network information comprises current network congestion statistics.

15. The computer-implemented method of claim 10, wherein
the first carrier network instructs the UE to configure the parameters of the UE for the second carrier network, and
the second carrier network is determined based on a subscription of the UE, current or anticipated future congestion conditions on the first carrier network, or a determination that an event likely to cause congestion conditions is occurring or will occur.

16. The computer-implemented method of claim 10, further comprising:
training an artificial intelligence (AI)/machine learning (ML) model for policy-based network selection, by the one or more computing systems, using signal strength data, congestion data, location data, data pertaining to carrier networks, signal-to-noise ratio (SNR) data, signal to interference and noise ratio (SINR) data, throughput data, call quality data, or any combination thereof; and
using the trained AI/ML model to determine that the UE should attach to the different carrier network based on the policy, determine the second carrier network that the UE should attach to based on the policy, or both, by the one or more computing systems.

17. A computing system, comprising:
memory storing computer program instructions for performing policy-based network selection; and
at least one processor configured to execute the computer program instructions, wherein the computer program instructions are configured to cause the at least one processor to:
determine, based on a policy of user equipment (UE) attached to a first carrier network, that the UE should attach to a different carrier network;
determine a second carrier network that the UE should attach to based on the policy using, at least in part, a trained artificial intelligence (AI)/machine learning (ML) model for policy-based network selection; and
instruct the UE to configure parameters of the UE for the second carrier network.

18. The computing system of claim 17, wherein the parameters to be configured by the UE for the second carrier network comprise activation of one or bands, deactivation of one or more bands, changing a band selection order, changing a packet size, using carrier aggregation (CA), using a universal subscriber identity module (SIM), choosing a lowest cost available carrier network that meets minimum quality parameters, choosing a carrier network with a highest quality, or any combination thereof.

19. The computing system of claim 17, wherein the computer program instructions are further configured to cause the at least one processor to:
receive information providing hardware capabilities of the UE, software capabilities of the UE, or both; and
use the received hardware capabilities of the UE, software capabilities of the UE, or both, in the determining of the second carrier network that the UE should attach to based on the policy.

20. The computing system of claim 17, wherein the second carrier network is determined for a first service and the computer program instructions are further configured to cause the at least one processor to:
determine a third carrier network that the UE should attach to for a second service based on the policy; and
instruct the UE to configure the parameters of the UE for the third carrier network, wherein
the first service comprises data and the second service comprises voice and short message service (SMS), or vice versa.
